(19) United States
(12) Patent Application Publication
(10) Pub. No.: US 2015/0304326 A1
(43) Pub. Date: Oct. 22, 2015

(54) APPARATUS AND METHOD FOR DELEGATING MULTIMEDIA CONTENT IN COMMUNICATION SYSTEM

(71) Applicant: Samsung Electronics Co., Ltd., Gyeonggi-do (KR)

(72) Inventors: Kyung-Tak LEE, Gyeonggi-do (KR); Pattan Basavaraj JAYAWANT, Bangalore (IN); Gyu-Bong OH, Gyeonggi-do (KR)

(21) Appl. No.: 14/513,936

(22) Filed: Oct. 14, 2014

(30) Foreign Application Priority Data
Aug. 12, 2013 (KR) 10-2013-0095333

(51) Int. Cl. H04L 29/06; H04L 29/08

(52) U.S. Cl. CPC H04L 63/0884; H04L 67/10

(57) ABSTRACT

Methods and apparatuses are provided for delegating content in a communication system. A terminal detects an event for delegating authority to use the content. The terminal selects at least one other terminal to which the authority can be delegated. The terminal transmits, to a server, a message requesting to delegate the authority to the selected at least one other terminal. The server delegates the authority to the at least one other terminal. The server transmits, to the terminal, a result indicating whether the authority is successfully delegated or not.

### PRIORITY

This application claims priority under 35 U.S.C. §119 to an application filed in the Korean Intellectual Property Office on Aug. 12, 2013 and assigned Serial No. 10-2013-0095333, the content of which is incorporated herein by reference.

### BACKGROUND OF THE INVENTION

1. Field of the Invention

The present invention relates generally to multimedia contents in a communication system.

2. Description of the Related Art

A variety of multimedia content has been introduced to provide users with a wide variety of experiences in a home environment. For example, three (3) dimensional (3D) contents, multi-view contents, and 7.1 channel contents have been provided.

With the introduction of the multimedia content, paid content is also provided. However, a user who paid a fee for content may not use the corresponding content or may not wish to use the content. For example, a user purchases broadcasting program content, but cannot view the broadcasting program because something happens at a scheduled viewing time of the broadcasting program, or the user may not wish to view the program because the user is no longer interested in the broadcasting program. Such situations may reduce users' desire to purchase paid content, and thus, may make the paid content market stagnate.

### SUMMARY OF THE INVENTION

The present invention has been made to address at least the above problems and/or disadvantages and to provide at least the advantages described below. Accordingly, an aspect of the present invention provides a method and an apparatus by which a specific user delegates authority to use multimedia content to another user terminal in a communication system.

Another aspect of the present invention provides a method and an apparatus for delegating authority to use multimedia content between users based on a Session Initiation Protocol (SIP) in a communication system supporting an International Softswitch Consortium (ISC).

Another aspect of the present invention provides a method and apparatus by which a first user terminal is delegated authority to use multimedia content by a second user terminal and uses the corresponding multimedia content based on the delegated use authority in a communication system.

Another aspect of the present invention provides a method and an apparatus for delegating authority to use multimedia content to a second user terminal according to a multimedia content use authority delegation request of a first user terminal in a server of a communication system.

According to an aspect of the present invention, a method of a terminal is provided for delegating content in a communication system. The terminal detects an event for delegating authority to use the content. The terminal selects at least one other terminal to which the authority can be delegated. The terminal transmits, to a server, a message requesting to delegate the authority to the selected at least one other terminal. The terminal receives a result indicating whether the authority is successfully delegated from the server.

According to another aspect of the present invention, a method of a server is provided for delegating content between terminals in a communication system. The server receives, from a first terminal, a message requesting to delegate authority to use the content to at least one other terminal. The server delegates the authority of the first terminal to the at least one other terminal. The server transmits, to the first terminal, a result indicating whether the authority is successfully delegated or not.

According to another aspect of the present invention, a method of a terminal is provided for being delegated content in a communication system. The terminal receives, from a server, authority delegated by a first terminal, to use the content. The terminal uses the content based on the authority of the first terminal.

According to another aspect of the present invention, a terminal is provided for delegating content in a communication system. The terminal includes a communicator configured to exchange signals with a server. The terminal also includes a controller configured to control functions of detecting an event for delegating authority to use the content, selecting at least one other terminal to which the authority can be delegated, transmitting to the server a message requesting to delegate the authority to the selected at least one another terminal, and receiving a result indicating whether the authority is successfully delegated from the server.

According to another aspect of the present invention, a server is provided for delegating content between terminals in a communication system. The server includes a communicator configured to exchange signals with a plurality of terminals. The server also includes a controller configured to control functions of receiving from a first terminal a message requesting to delegate authority to use the content to at least one other terminal, delegating the authority of the first terminal to the at least one other terminal, and transmitting a result indicating whether the authority is successfully delegated or not to the first terminal.

According to another aspect of the present invention, a terminal is provided for being delegated content in a communication system. The terminal includes a communicator configured to exchange signals with a server. The terminal also includes a controller configured to control functions of receiving authority delegated by a first terminal, to use the content from the server, and using the content based on the authority of the first terminal.

### BRIEF DESCRIPTION OF THE DRAWINGS

The above and other aspects, features, and advantages of the present invention will become more apparent from the following detailed description when taken in conjunction with the accompanying drawings in which:

FIG. 1 is a diagram illustrating a configuration of a system, according to an embodiment of the present invention;

FIG. 2A is a diagram illustrating a procedure for delegating content between user terminals in a communication system, according to an embodiment of the present invention;

FIG. 2B is a diagram illustrating a procedure for delegating content between user terminals in a communication system, according to another embodiment of the present invention;

FIG. 3A is a diagram illustrating a procedure for delegating content between user terminals by using an SIP in a communication system, according to an embodiment of the present invention;

FIG. 3B is a diagram illustrating a procedure for delegating content between user terminals by using an SIP in a communication system, according to another embodiment of the present invention;

FIG. 4 is a flowchart illustrating a procedure for delegating authority to use multimedia content to another user terminal in a user terminal of a communication system, according to an embodiment of the present invention;

FIG. 5A is a flowchart illustrating a procedure for delegating a specific user terminal's authority to use multimedia content to another user terminal in a server of a communication system, according to an embodiment of the present invention;

FIG. 5B is a flowchart illustrating a procedure for delegating a specific user terminal's authority to use multimedia content to another user terminal in a server of a communication system, according to another embodiment of the present invention;

FIG. 6 is a flowchart illustrating a procedure in which a user terminal is delegated authority to use a multimedia content by another user terminal in a communication system, according to an embodiment of the present invention;

FIG. 7 is a diagram illustrating a block configuration of a user terminal in a communication system, according to an embodiment of the present invention; and

FIG. 8 is a diagram illustrating a block configuration of a server in a communication system, according to an embodiment of the present invention.

### DETAILED DESCRIPTION OF THE EMBODIMENTS OF THE PRESENT INVENTION

Embodiments of the present invention are described in detail with reference to the accompanying drawings. The same or similar components may be designated by the same or similar reference numerals. Detailed descriptions of constructions or processes known in the art may be omitted to avoid obscuring the subject matter of the present invention. Also, the terms used herein are defined according to the functions of the present invention. Thus, the terms may vary depending on users' or operators' intentions or practices. Therefore, the terms used herein should be understood based on the descriptions made herein.

Hereinafter, a method and an apparatus are described for delegating authority to use multimedia content between user terminals in a communication system. In particular, a method for delegating authority to use multimedia content between users by using a SIP-based message in a communication system supporting an ISC is described by way of an example. However, authority to use multimedia content may be delegated between user terminals by using messages of other formats in addition to the SIP-based message. The multimedia content recited herein includes various types of contents such as, for example, 3D content, multi-view content, 7.1 channel content, broadcasting program content, image content, text content, audio content, video content, etc. Herein, the multimedia content will be referred to as “content” for convenience of explanation. In addition, herein, the terms “terminal”, “user terminal”, and “client” will be used interchangeably, but can be interpreted as meaning a user or a user's communication device. The user's communication device includes, for example, a mobile communication terminal, a smart phone, a tablet Personal Computer (PC), a digital camera, an MP3, a navigation system, a laptop, a netbook, a computer, a smart TV, etc. In addition, the terms “use authority” and “authority” will be used interchangeably, but can be interpreted as meaning authority to use all contents.

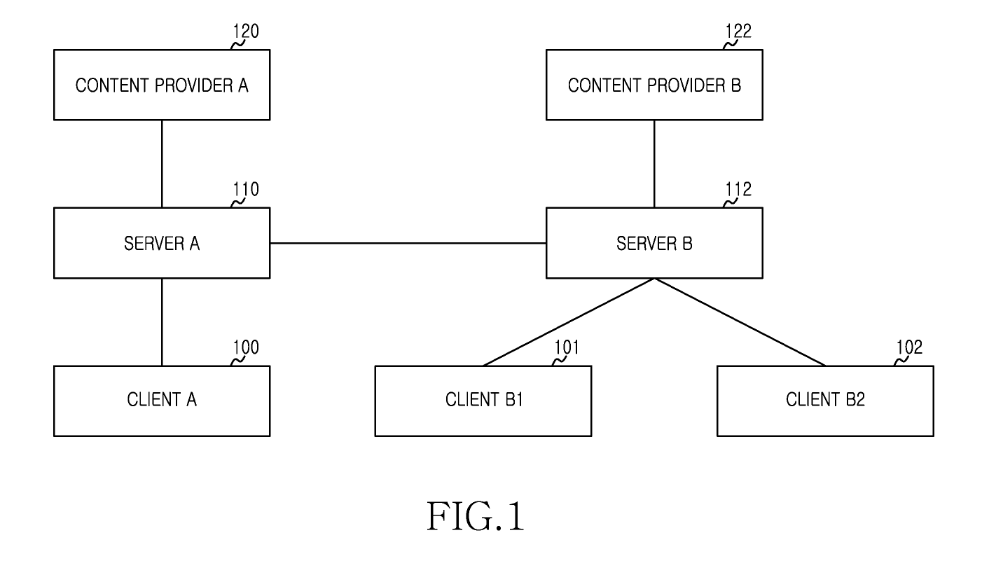

FIG. 1 is a diagram illustrating a configuration of a system, according to an embodiment of the present invention.

Referring to FIG. 1, a content provider (or a content providing server) A 120 provides content to a server A 110, and a content provider B 122 provides content to a server B 112. In an embodiment of the present invention, it is assumed that content is accessible or usable only by a user having authority to use it (or a user terminal).

The server A 110 may forward the content provided by the content provider A 120 to a client A 100. In this case, the server A 110 may forward the content, which the client A 100 acquires authority to use by purchasing it or subscribing to a service, to the client A 100. According to an embodiment of the present invention, the server A 110 may be requested by the client A 100 to delegate authority to use specific content to a client B1 101 or a client B2 102, or may interwork with the server B 112 to delegate the authority to use the specific content to the client B1 101 or the client B2 102.

The server B 112 may forward the content provided by the content provider B 122 to the client B1 101 and/or the client B2 102. In this case, the server 112 may forward the content, which the client B1 101 and the client B2 102 acquire authority to use by purchasing the contents or subscribing to a service, to the client B1 101 and the client B2 102, respectively. According to an embodiment of the present invention, the server B 112 may interwork with the server A 110 and may be requested by the client A 100 connected to the server A 110 to delegate authority to use specific content, and accordingly, may delegate the authority to use the specific content, which is owned by the client A 100, to the client B1 101 or the client B2 102. The server B 112 may correspond to a mobile network operator, which is different from the server A 110. For example, the server A 110 may connect clients supporting a first mobile network, and the server B 112 may connect clients supporting a second mobile network.

The client A 100 may receive content from the server A 110, reproduce the content, and output the content through a display device and an audio device. When an event to delegate authority to use content to the client B1 101 or the client B2 102 is generated by a user request, the client A 100 may delegate the content use authority to the client B1 101 or the client B2 102 through the server A 110. In this case, the client A 100 cannot use the corresponding content after delegating the content use authority to the client B 101 or the client B2 102.

Each of the clients B1 101 and B2 102 may receive content from the server B 112, reproduce the content, and output the content through a display device and an audio device. Each of the clients B1 101 and B2 102 may be delegated authority to use content by the user A 100 through the server B 112. Each of the clients B1 101 and B2 102 may use the corresponding content through the server B 112 by using the delegated content use authority.

As shown in FIG. 1, it is assumed that authority to use content is delegated between clients belonging to different mobile networks in an embodiment of the present invention. However, authority to use content may be delegated between clients belonging to a same mobile network. In this case, a client that wishes to delegate authority to use content and a client that is delegated authority to use content may exchange signals related to delegation of content use authority through a same server.

Hereinafter, a client requesting to delegate content use authority will be referred to as a “delegation requester”, and a client that will be delegated authority to use content will be referred to as a “delegation receiver”, for convenience of explanation.

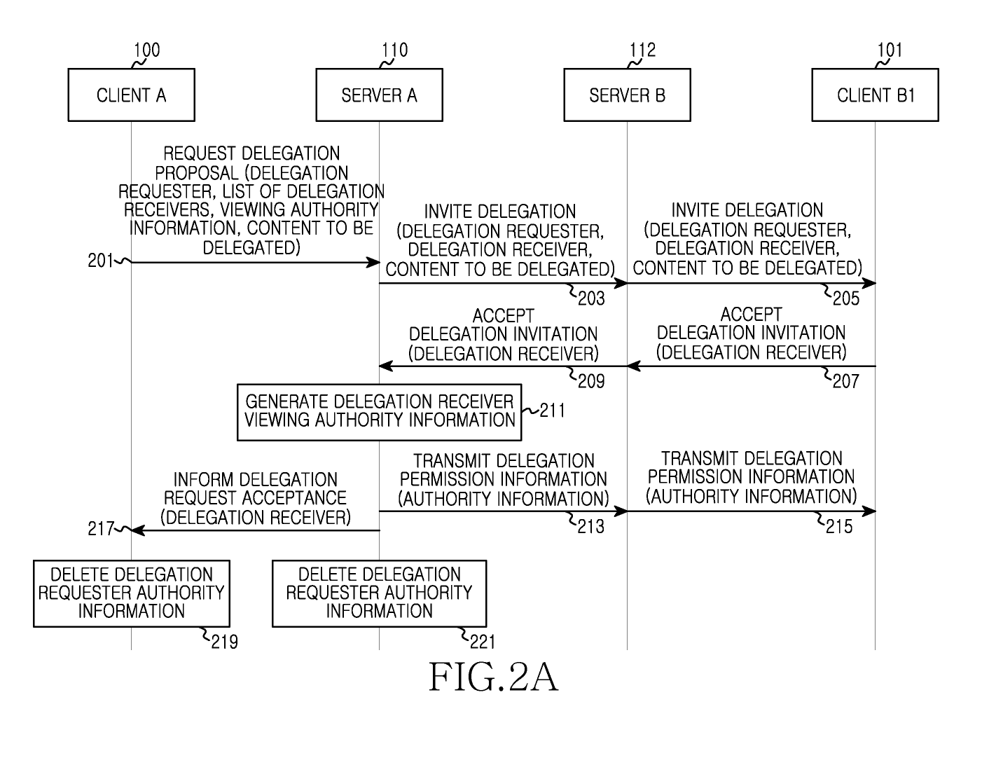

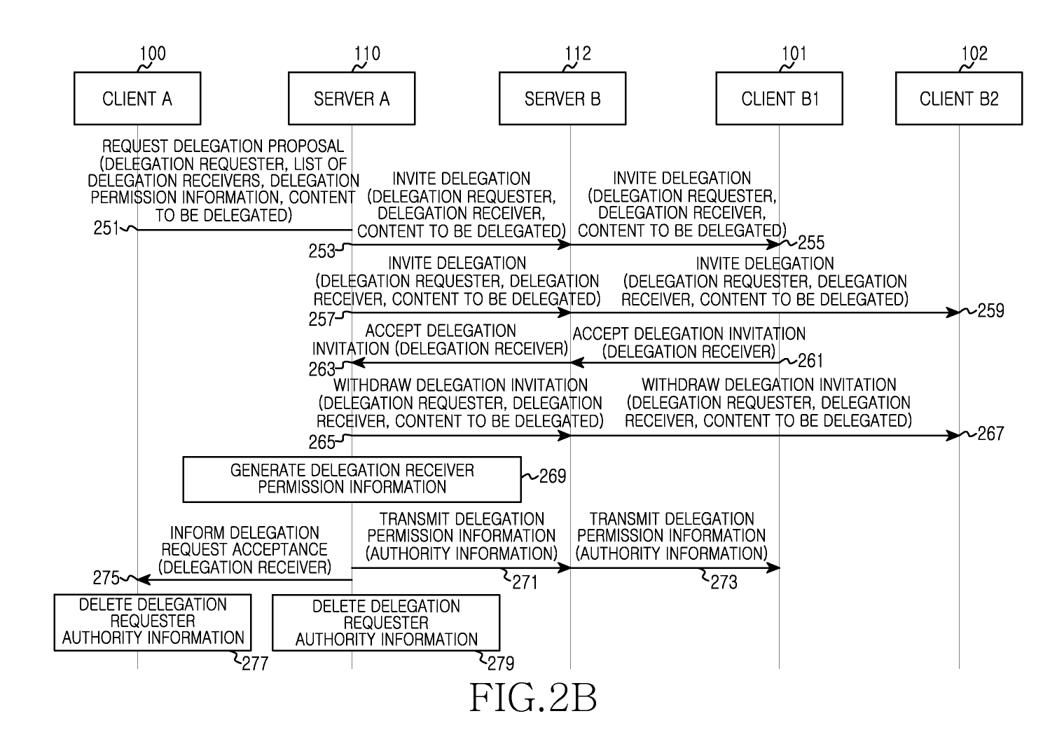

FIG. 2A is a diagram illustrating a procedure for delegating content between user terminals in a communication system, according to an embodiment of the present invention. Herein, it is assumed that a single client will be delegated authority to use content, namely, there is a single delegation receiver.

Referring to FIG. 2A, the client A 100 detects an event to delegate authority to use specific content to another user under control of a user. In step 201, the client A 100, which detects the event to delegate the authority to use the content, generates a delegation proposal request message including a delegation requester, a delegation receiver, authority information, and details to be delegated, and transmits the delegation proposal request message to the server A 110. For example, the user of the client A 100 may request to delegate authority to view a broadcasting program A to the client B1 101 through a user interface, and accordingly, the client A 100 may generate a delegation proposal request message including identification information of the client A 100 (e.g., address information), identification information of the client B1 101 (e.g., address information), information on authority to view the broadcasting program A (e.g., a login ID, a password, and a viewing authority token), and information on the broadcasting program A (e.g., a title, channel information, a start time, and an end time), and may transmit the delegation proposal request message to the server A 110.

In step 203, the server A 110, which receives the delegation proposal request message from the client A 100, identifies a delegation receiver from the delegation proposal request message, and transmits a delegation invitation message to the server B 112 to which the delegation receiver belongs. The server A 110 may identify that the delegation receiver to be delegated the authority to use the content is the client B1 101 and the client B1 101 belongs to the server B 112 based on the identification information of the delegation receiver. In this case, the delegation invitation message may include the delegation requester, the delegation receiver, and information on the details to be delegated.

In step 205, the server B 112, which receives the delegation invitation message from the server A 110, identifies that the delegation receiver is the client B1 101 from the delegation proposal request message and forwards the delegation invitation message to the client B1 101.

The client B1 101, which receives the delegation invitation message, analyzes the delegation invitation message and provides the user with information indicating that delegation of the authority to use the specific content is proposed by the client A 100, and determine whether to accept the delegation under control of the user. When it is determined that the delegation is accepted under control of the user, the client B1 101 transmits a delegation invitation acceptance message including delegation receiver information to the server B 112, in step 207. That is, the client B1 101 transmits the delegation invitation acceptance message including its own identification information to the server B 112 to be delegated the authority to use the corresponding content. The server B 112 forwards the delegation invitation acceptance message received from the client B1 101 to the server A 110, in step 209.

The server A 110 analyzes the received delegation invitation acceptance message, identifies that the client B1 101, which is the delegation receiver, accepted the delegation of the content use authority, and generates content use authority information to be transmitted to the client B1 101, in step 211. For example, the server A 110 may generate at least one of a login ID, a password, and a viewing authority token regarding the content to be delegated, or may change at least one of a login ID, a password, and a viewing authority token which are used by the client A 100. According to an embodiment of the present invention, the operation of generating the content use authority information to be transmitted to the client B1 101 may be performed before step 203 or may be performed between steps 203 and 209. Thereafter, the server A 110 transmits a delegation permission information transmit message including the content use authority information to the server B 112, in step 213.

In step 215, the server B 112 forwards the received delegation permission information transmit message to the client B1 101. The client B1 101, which receives the delegation permission information transmit message, may access or use the corresponding content based on authority information included in the delegation permission information transmit message. For example, the client B1 101 may view the broadcasting program A by using the viewing authority token.

After transmitting the delegation permission information transmit message to the server B 112, the server A 110 transmits a delegation request acceptance notification message including the delegation receiver information to the client A 100, in step 217. That is, the server A 110 may transmit a message indicating that the content is completely delegated to the client B 101.

Thereafter, the client A 100 and the server A 110 delete the information on the authority to use the corresponding content, in steps 219 and 221. That is, since the client A 100 delegates the authority to use the content to the client B1 101, the client A 100 loses the authority to use the corresponding content. Accordingly, the client A 100 and the server A 110 delete the information on the authority of the client A 100 to use the corresponding content. According to an embodiment of the present invention, the client A 100 and the server A 110 may not delete the information on the authority to use the content and may add information indicating that the use authority is not effective, in steps 219 and 221.

FIG. 2B is a diagram illustrating a procedure for delegating content between user terminals in a communication system, according to another embodiment of the present invention. Herein, it is assumed that there are two candidate clients to be delegated authority to use content, namely, there are two delegation receivers, and one of the two delegation receivers is delegated the authority to use content. The same method applies when there are two or more delegation receivers to be delegated authority to use content.

Referring to FIG. 2B, the client A 100 detects an event to delegate authority to use specific content to another user under control of a user. In step 251, the client A 100, which detects the event to delegate the authority to use the content, generates a delegation proposal request message including a delegation requester, a delegation receiver list indicating a plurality of delegation receivers, authority information, and details to be delegated, and transmits the delegation proposal request message to the server A 110. For example, the user of the client A 100 may request to delegate authority to view a broadcasting program A to one of the client B1 101 and the client B2 102 through a user interface, and accordingly, the client A 100 may generate a delegation proposal request message including identification information of the client A 100 (e.g., address information), identification information of the client B1 101 (e.g., address information), identification information of the client B2 102 (e.g., address information), information on authority to view the broadcasting program A (e.g., a login ID, a password, and a viewing authority token), and information on the broadcasting program A (e.g., a title, channel information, a start time, and an end time), and may transmit the delegation proposal request message to the server A 110.

The server A 110, which receives the delegation proposal request message from the client A 100, identifies delegation receivers from the delegation proposal request message, and transmits a delegation invitation message to the server B 112 to which the delegation receivers belong, in steps 253 and 257. The server A 110 may identify identification information of the delegation receivers from the delegation receiver list, and may identify that the delegation receivers to be delegated the authority to use the content are the client B1 101 and the client B2 102 and that the client B1 101 and the client B2 102 belong to the server B 112 based on the identification information of the delegation receivers. In this case, the delegation invitation message may include the delegation requester, the delegation receivers, and information on the details to be delegated. Since the two delegation receivers are identified, the server A 110 generates two delegation invitation messages and transmits each of them to the server B 112, in steps 253 and 257. However, according to an embodiment of the present invention, the server A 110 may transmit a single delegation invitation message indicating a plurality of delegation receivers to the server B 112. Steps 253 and 257 may be performed at a same point of time or may be performed serially.

The server B 112 identifies delegation receivers corresponding to each of the delegation invitation messages from the received delegation invitation messages, and forwards the delegation invitation messages to the client B1 101 and the client B2 102, which are the delegation receivers, in steps 255 and 259.

Each of the client B1 101 and the client B2 102, which receive the delegation invitation messages, analyze the delegation invitation messages and provide users with information indicating that delegation of the authority to use the specific content is proposed by the client A 100, and determine whether to accept the delegation under control of the users. According to an embodiment of the present invention, it is assumed that the client B1 101 accepts the delegation under control of the user, whereas the client B2 102 does not determine whether to accept the delegation.

The client B1 101, which accepted the delegation, transmits a delegation invitation acceptance message including its own identification information as delegation receiver information to the server B 112 to be delegated the authority to use the corresponding content, in step 261. The server B 112 forwards the delegation invitation acceptance message received from the client B1 101 to the server A 110, in step 263.

The server A 110 analyzes the received delegation invitation acceptance message, identifies that the client B1 101, which is the delegation receiver, accepted the delegation of the content use authority, generates a delegation invitation withdrawal message for the client B2 102, and transmits the delegation invitation withdrawal message to the server B 112, in step 265. The server B 112 forwards the delegation invitation withdrawal message to the client B2 102, in step 267. That is, since the server A 110 decides to delegate the content use authority of the client A to the client B1 101, the server A 110 cannot delegate the use authority to the client B2 102. Accordingly, the server A 110 may transmit the delegation invitation withdrawal message to the client B2 102 through the server B 112, and the delegation invitation withdrawal message may include the same information as the delegation invitation message transmitted in step 257. In addition, the delegation invitation withdrawal message may include information indicating that the authority to use the corresponding content is delegated to the client B1 101. The client B2 102, which receives the delegation invitation withdrawal message, may provide the user with information indicating that the delegation of the authority to use the specific content is withdrawn.

The server A 110 generates content use authority information to be transmitted to the client B1 101, in step 269. For example, the server A 110 may generate at least one of a login ID, a password, and a viewing authority token regarding the content to be delegated, or may change at least one of a login ID, a password, and a viewing authority token which are used by the client A 100. According to an embodiment of the present invention, the operation of generating the content use authority information to be transmitted to the client B1 101 may be performed before step 253 or may be performed between steps 253 and 275. When the server A 110 generates the content use authority information prior to receiving the delegation invitation acceptance message, the server A 110 cannot know which delegation receiver will accept the delegation of the authority to use the content and thus generates temporary use authority information, and, when a delegation invitation acceptance message is received afterward and a delegation receiver is determined, may modify the temporary use authority information according to the determined delegation receiver.

Thereafter, the server A 110 transmits a delegation permission information transmit message including the content use authority information to the server B 112, in step 271, and the server B 112 forwards the received delegation permission information transmit message to the client B1 101, in step 273. The client B1 101, which receives the delegation permission information transmit message, may access or use the corresponding content based on the authority information included in the delegation permission information transmit message. For example, the client B1 101 may view the broadcasting program A by using the viewing authority token.

After transmitting the delegation permission information transmit message to the server B 112, the server A 110 transmits a delegation request acceptance notification message including the delegation receiver information to the client A 100, in step 275. That is, the server A 110 may transmit a message indicating that the content is completely delegated to the client B 101.

Thereafter, the client A 100 and the server A 110 delete the information on the authority to use the corresponding content, in steps 277 and 279. That is, since the client A 100 delegates the authority to use the content to the client B1 101, the client A 100 loses the authority to use the corresponding content. Accordingly, the client A 100 and the server A 110 delete the information on the authority of the client A 100 to use the corresponding content. According to an embodiment of the present invention, the client A 100 and the server A 110 may not delete the information on the authority to use the content and may add information indicating that the use authority is not effective, in steps 277 and 279.

In FIG. 2B, it is assumed that, out of the client B1 101 and the client B2 102, which receive the delegation invitation message, only the client B 101 accepts the delegation invitation. However, a plurality of clients that receive a delegation invitation message may accept the delegation invitation and may transmit a delegation invitation acceptance message to a corresponding server. In this case, the server may determine a client from which a delegation invitation acceptance message is received first as a delegation receiver, and may determine a client that decides to accept the delegation invitation first as a delegation receiver. When the client that decides to accept the delegation invitation first is determined as a delegation receiver, the delegation invitation acceptance message may include information on a point of time when the user accepts the delegation invitation.

FIGS. 2A and 2B simplify the procedure for delegating the content between user terminals for convenience of explanation. However, although not shown in FIGS. 2A and 2B, a client and a server or a server and a server may exchange a response message in response to an exchanged request and/or notification message.

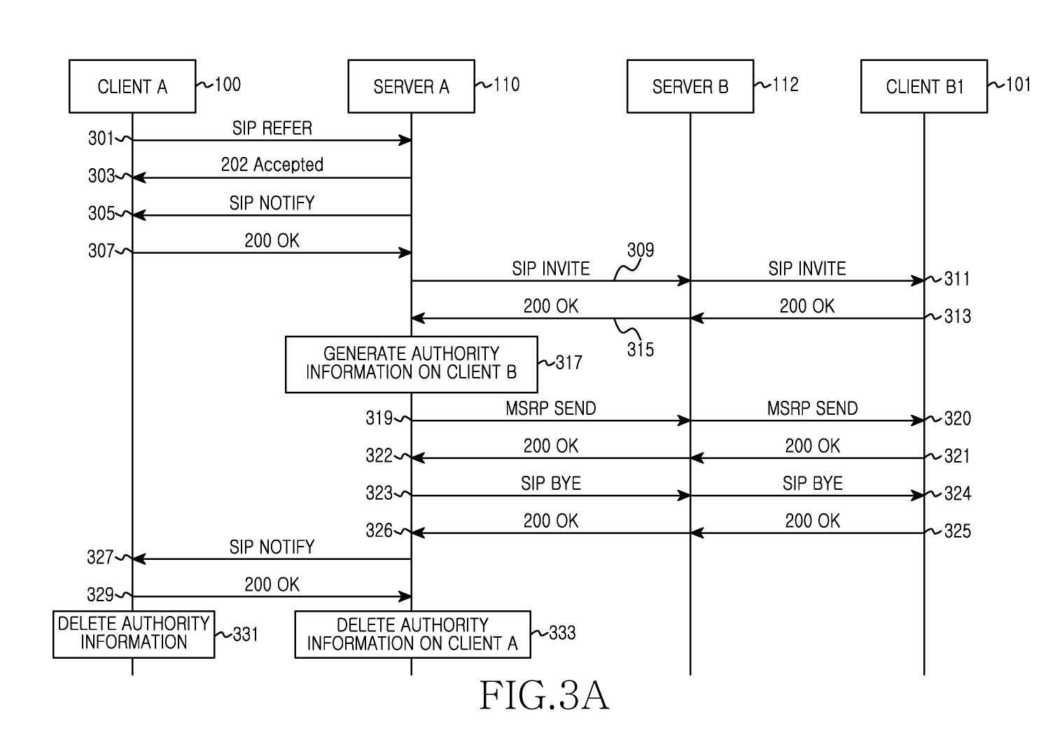

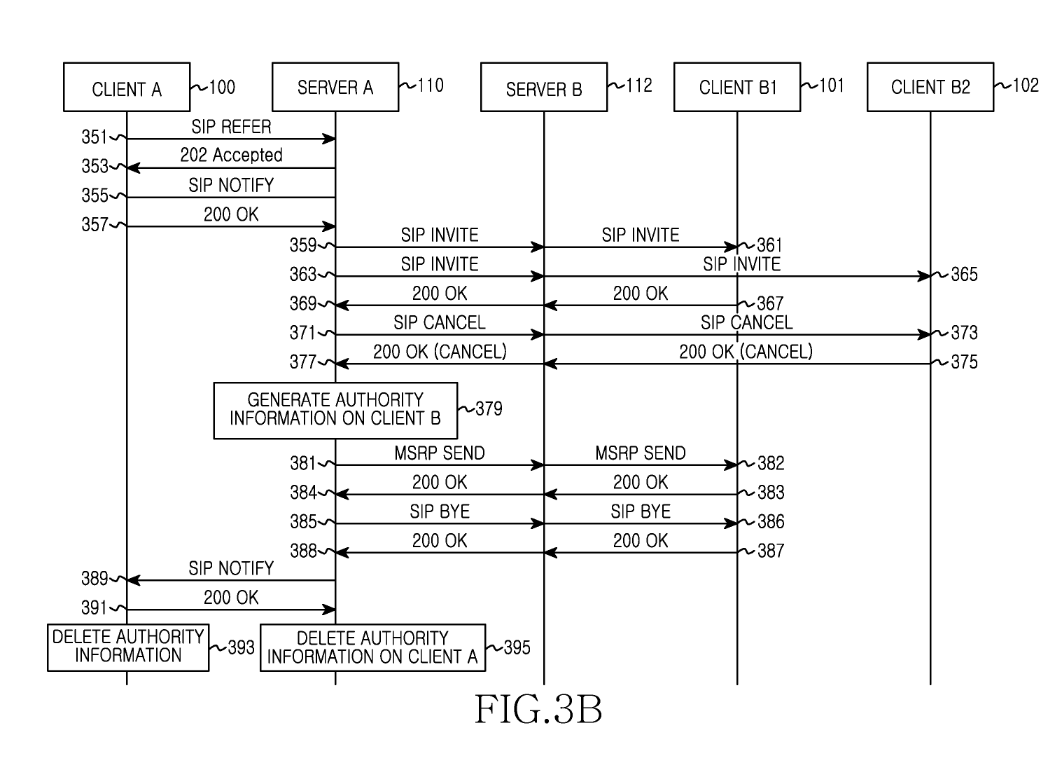

Hereinafter, a method for delegating authority to use multimedia content between users by using an SIP-based message in a communication system supporting an ISC is explained by way of an example, based on FIGS. 2A and 2B. Hereinafter, each step illustrated in FIGS. 3A and 3B may be mapped to each step described with respect to FIGS. 2A and 2B.

FIG. 3A is a diagram illustrating a procedure for delegating content between user terminals by using a SIP in a communication system, according to an embodiment of the present invention. Herein, it is assumed that there is a single client to be delegated authority to use content, namely, there is a single delegation receiver.

Referring to FIG. 3A, the client A 100, which detects an event to delegate authority to use a specific content to another user under control of a user, generates an SIP REFER message including a delegation requester, a delegation receiver, authority information, and details to be delegated and requesting a delegation proposal, and transmits the generated SIP REFER message to the server A 110, in step 301. Herein, the SIP REFER message may be generated as shown in Table 1 below, for example:

TABLE 1
REFER sip:serverA@domainA.com SIP/2.0
Via: SIP/2.0/UDP clientA@domainA.com;branch=z9hG4bK2293940223
To: <sip:serverA@domainA.com>;
From: <sip:userA@domainA.com>;tag=193402342
Call-ID: 898234234@agentA.domainA.com
CSeq: 93809823 REFER
Max-Forwards: 70
Refer-To: <sip:userB1@domainB.com;method=INVITE>
Contact: sip:clientA@domainA.com
Require: recipient-list-invite, multiple-refer
Content-Type: multipart/related;

boundary=“boundary71”

Content-Length: [length]
--boundary71
Content-Type: application/vnd.oma.isc.authinfo
Content-Transfer-Encoding: binary
Content-ID: <id2@clientA.domainA.com>
Content-Length: [length of authentication info data]
Content-Disposition: attachment
[Data containing authentication info for userA]
--boundary71--
Content-Type: text/plain
Content-ID: <id3@clientA.domainA.com>
Content-Length: [length of info about content to be delegated]
[Info about content to be delegated]
--boundary71--

As shown in Table 1, the SIP REFER message, according to an embodiment of the present invention, includes SIP address information of the client A 100, “sip:userA@domainA.com”, which is identification information of a delegation requester, in a “From” header, and includes address information of the client B1 101, “sip:userB1@domainB.com”, which is identification information of a delegation receiver, in a “Refer-To” header. Herein, the SIP REFER message includes “method=INVITE” in the “Refer-To” header, so that the client A 100 may request the server A 110 intended to receive the SIP REFER message to transmit a SIP INVITE message to the client B1 101. In addition, the SIP REFER message may include information on authority to use content. In an embodiment of the present invention, a Multipurpose Internet Mail Extensions (MIME) type, “application/vnd.oma.isc.authinfo”, is defined to forward the information on the authority to use the content, and such an MIME type is included in the SIP REFER messages, thereby indicating that the use authority information is included in the corresponding SIP REFER message. In addition, the SIP REFER message may include details on content to be delegated. In an embodiment of the present invention, an MIME type, “text/plain” is used to forward details on content to be delegated. However, a new MIME type may be defined to forward details on content to be delegated.

The server A 110, which receives the SIP REFER message requesting the delegation proposal from the client A 100, transmits a 202 Accepted message, which is a response message indicating that the function requested through the SIP REFER message will be performed, to the client A 100, in step 303, and transmits an SIP NOTIFY message to the client A 100, in step 305. In this case, the SIP NOTIFY message may be a message that should be transmitted to the client A 100 first in order to transmit a result of the request of the SIP REFER to the client A 100 afterward. The client A 100 transmits a response message 200 OK indicating that the message is successfully received from the server A 110, to the server A 110, in step 307.

The server A 110 identifies that the delegation receiver is the client B1 101 from the SIP REFER message requesting the delegation proposal, and transmits a SIP INVITE message, indicating a delegation invitation, to the server B 112 to which the client B1 101 belongs, in step 309. The server B 112 forwards the SIP INVITE message received from the server A 110 to the client B1 101, in step 311. Herein, the SIP INVITE message may be configured as shown in Table 2 below, for example:

TABLE 2
To: <sip:userB1@domainB.com>
From: <sip:userA@domainA.com>;tag=193402342
Refer-by: <sip:userA@domainA.com>
(...)
Content-Type: multipart/related; type=“application/sdp”;

boundary=“boundary71”

Content-Length: [length]
--boundary71

Content-Type: application/sdp
Content-Length: [length of SDP]

v=0
o=userA 2890844526 2890844527 IN IP4 serverA.domainA.com
s=
t=0 0
m=message 7394 TCP/TLS/MSRP *
i=This is an ISC delegation transfer request
e=serverA@domainA.com
a=sendonly
a=accept-types:message/cpim
a=accept-wrapped-types:*
a=file-selector:name:“Auth_info.isc”
type:application/vnd.oma.isc.authinfo

size:[size of auth info] hash:sha-1:
72:24:5F:E8:65:3D:DA:F3:71:36:2F:86:D4:71:91:3E:E4:A2:CE:2E

a=file-transfer-id:Q6LMoGymJdh0IKIgD6wD0jkcfgva4xvE
a=file-date:creation:“Mon, 15 May 2006 15:01:31 +0300”
a=path:msrp://serverA.domainA.com:7394/2s93i93idj;tcp
--boundary71--
Content-Type: text/plain
Content-ID: <id3@clientA.domainA.com>
Content-Length: [length of info about content to be delegated]
[Info about content to be delegated]
--boundary71--

As shown in Table 2, the SIP INVITE message, according to an embodiment of the present, invention includes SIP address information of the client A 100, “sip:userA@domainA.com”, which is identification information of a delegation requester, in a “From” header, and includes address information of the client B1 101, “sip:userB1@domainB.com”, which is identification information of a delegation receiver, in a “To” header. In addition, the SIP INVITE message, according to an embodiment of the present invention, may include an MIME type, “application/vnd.oma.isc.authinfo”, to inform that the corresponding message is an invitation message to delegate content use authority, and also may include information on authority to use the content to be delegated. The MIME type suggested in an embodiment of the present invention may be forwarded in a file transfer method by using a Session Description Protocol (SDP). In addition, the SIP INVITE message may include details on a content to be delegated by using an MIME type, “text/plain”. In addition, the server A 110 may include additional information related to details on content to be delegated to the SIP INVITE message based on the use authority information of the delegation requester. For example, the SIP INVITE message may include an advertisement image thumbnail on a broadcasting program or URL ( ) information for viewing a moving image preview. In this case, when additional information to be added to the SIP INVITE message does not correspond to the MIME type, “text/plain”, the server A 110 may add the corresponding additional information to the SIP INVITE message by using another MIME type (e.g., “image/jpeg”) corresponding to the additional information.

The client B1 101, which receives the SIP INVITE message indicating the delegation invitation, analyzes the delegation invitation message and may provide the user with information indicating that delegation of the authority to use the specific content is proposed by the client A 100, and determines whether to accept the delegation under control of the user. When the delegation is accepted under control of the user, the client B1 101 transmits a 200 OK message indicating acceptance of the delegation invitation to the server B 112 to be delegated the authority to use the corresponding content, in step 313, and the server B 112 forwards the 200 OK message to the server A 110, in step 315. Herein, the 200 OK message may be configured as shown in Table 3 below, for example:

TABLE 3
SIP/2.0 200 OK
Via: SIP/2.0/UDP serverB.domainB.com;branch=y8gK3vJ227Gh394643
Via: SIP/2.0/UDP serverA.domainA.com;branch=z9hG4bK22Gh394643
To: <sip:serverA.domainA,com>
From: <sip:userB1@domainB.com>;tag=193402342
(...)
Content-Type: application/sdp;
Content-Length: [length of SDP]
v=0
o=userB1 2890844656 2890844656 IN IP4 clientB1.domainB.com
s=
c=IN IP4 clientB1.domainB.com
t=0 0
m=message 8888 TCP/TLS/MSRP *
a=recvonly
a=accept-types:message/cpim
a=accept-wrapped-types:*
a=path:msrp://clientB.domainB.com:8888/9di4ea;tcp
a=file-selector:name:“Auth_info.isc”
type:application/vnd.oma.isc.authinfo
size:[size of auth info] hash:sha-1:

72:24:5F:E8:65:3D:DA:F3:71:36:2F:86:D4:71:91:3E:E4:A2:CE:2E

a=file-transfer-id:Q6LMoGymJdh0IKIgD6wD0jkcfgva4xvE

As shown in Table 3, the 200 OK message, according to an embodiment of the present invention, includes SIP address information of the client B1 101, “sip:user A@domainA.com”, which is identification information of a delegation receiver, in a “From” header, thereby indicating that the client B1 101 accepted delegation of the content use authority. In addition, the 200 OK message, according to an embodiment of the present invention includes an MIME type, “application/vnd.oma.isc.authinfo”, to inform that the corresponding message is a message indicating acceptance of the content use authority.

The server A 110 may analyze the received 200 OK message and may identify that the client B1 101 accepted the delegation of the content use authority, and accordingly, a session may be formed between the server A 110 and the client B1 101. The server A 110 generates viewing authority information to be transmitted to the client B1 101, in step 317. According to an embodiment of the present invention, the server A 110 generates the content use authority information to be transmitted to the client B1 101 prior to performing step 309.

Thereafter, the server A 110 transmits an MSRP SEND message including the content use authority information to the server B 112, in step 319. The server B 112 forwards the MSRP SEND message to the client B1 101, in step 320. Accordingly, the client B1 101 may access or use the corresponding content based on the received content use authority information. Herein, the MSRP SEND message may be configured as shown in Table 4 below, for example:

TABLE 4

MSRP SEND

To-Path: msrp://clientB1.domainB.com:8888/9di4ea;tcp
From-Path: msrp://serverA.domainA.com:7394/2s93i93idj;tcp

Message-ID: 12339sdqwer

Byte-Range: 1-2048/4385
Content-Type: message/cpim

To: <sip:userB1@domainB.com>
From: <sip:serverA@domainA.com>
DateTime: 2006-05-15T15:02:31-03:00
Content-Type: application/vnd.oma.isc.authinfo
Content-Transfer-Encoding: binary
Content-Length: [length of authentication info data]
Content-Disposition: attachment
[Data containing authentication info for userB1]

As shown in Table 4, the MSRP SEND message, according to an embodiment of the present invention, may include content use authority information, and may include an MIME type, “application/vnd.oma.isc.authinfo”, thereby indicating that the corresponding message includes the content use authority information.

The client B1 101 transmits a 200 OK message to the server B 112 in response to the MSRP SEND message, in step 321, and the server B 112 forwards the 200 OK message received from the client B1 101 to the server A 110, in step 322.

The server A 110 identifies that the authority to use the content successfully arrives at the client B1 101 through the 200 OK message and determines that the session with the client B 101 is no longer needed, and then transmits a SIP BYE message to end the session with the client B 101 to the server B 112, in step 323. The server B 112, which receives the SIP BYE message, forwards the SIP BYE message to the client B 101, in step 324.

Thereafter, the client B1 101 transmits a 200 OK message to the server B 112 as a response message to the end of the session, in step 325, and the server B 112 forwards the 200 OK message received from the client server B1 101 to the server A 110, in step 326. Accordingly, the session between the server A 110 and the client B1 101 ends.

Thereafter, the server A 110 transmits an SIP NOTIFY message, to notify that the authority to use the content is delegated to the client B1 101, to the client A 100, in step 327. Herein, the SIP NOTIFY message may be configured as shown in Table 5 below, for example:

TABLE 5
NOTIFY sip:clientA@domainA.com SIP/2.0
Via: SIP/2.0/UDP serverA.domainA.com;branch=z9hG4bK9323394234
To: <sip:userA@domainA.com>;tag=193402342
From: <sip:serverA@domainA.com>;tag=4992881234
Call-ID: 898234234@clientA.domainA.com
CSeq: 1993403 NOTIFY
Max-Forwards: 70
Event: refer
Subscription-State: terminated;reason=noresource
Contact: sip:serverA@domainA.com
Content-Type: message/sipfrag;version=2.0
Content-Length: 16
SIP/2.0 200 OK
Content-Type: application/sdp;
Content-Length: [length of SDP]
v=0
o=userB1 2890844656 2890844656 IN IP4 clientB1.domainB.com
s=
c=IN IP4 clientB.domainB.com
t=0 0
m=message 8888 TCP/TLS/MSRP *
a=recvonly
a=accept-types:message/cpim
a=accept-wrapped-types:*
a=path:msrp://clientB.domainB.com:8888/9di4ea;tcp
a=file-selector:name:“Auth_info.isc”
type:application/vnd.oma.isc.authinfo
size:[size of auth info] hash:sha-1:

72:24:5F:E8:65:3D:DA:F3:71:36:2F:86:D4:71:91:3E:E4:A2:CE:2E

a=file-transfer-id:Q6LMoGymJdh0IKIgD6wD0jkcfgva4xvE

As shown in Table 5, the SIP NOTIFY message, according to an embodiment of the present invention, includes user identification information of the client B1 101 and address information of the client B1 101 in an “(original)” parameter from among SDP response parameters, thereby informing the client A 100 of which client or which user is delegated the authority to use the content. In addition, the SIP NOTIFY message includes the MIME type, “application/vnd.oma.isc.authinfo”, defined in an embodiment of the present invention, thereby indicating that the corresponding message is a message related to the delegation of the content use authority.

Thereafter, the client A 100 transmits a 200 OK message to the server A 110 in response to the SIP NOTIFY message, in step 329, and deletes the information on the authority to use the content, which is delegated to the client B 101, in step 331. In addition, after receiving a response message to the SIP NOTIFY message from the client A 100, the server A 110 deletes the content use authority information on the client A 100, in step 333. That is, since the authority of the client A 100 to use the content is delegated to the client B1 101, the client A 100 loses the authority to use the corresponding content. According to an embodiment of the present invention, the client A 100 and the server A 110 may not delete the information on the authority to use the content and may add information indicating that the use authority is not effective (e.g., an usable flag), in steps 331 and 333.

FIG. 3B is a diagram illustrating a procedure for delegating content between user terminals by using a SIP in a communication system, according to another embodiment of the present invention. Herein, it is assumed that there are two candidate clients to be delegated authority to use content, namely, there are two delegation receivers, and one of the two delegation receivers is delegated authority to use a content. In an embodiment of the present invention described below, the same method applies when there are two or more delegation receivers to be delegated authority to use a content.

Referring to FIG. 3B, the client A 100, which detects an event to delegate authority to use a specific content to another user under control of a user, generates an SIP REFER message including a delegation requester, a delegation receiver list including a plurality of delegation receivers, authority information, and details to be delegated and requesting a delegation proposal, and transmits the generated SIP REFER message to the server A 110, in step 351. Herein, the SIP REFER message may be generated as shown in Table 6 below, for example.

TABLE 6
REFER sip:serverA@domainA.com SIP/2.0
Via: SIP/2.0/UDP clientA@domainA.com;branch=z9hG4bK2293940223
To: <sip:serverA@domainA.com>;
From: <sip:userA@domainA.com>;tag=193402342
Call-ID: 898234234@agentA.domainA.com
CSeq: 93809823 REFER
Max-Forwards: 70
Refer-To: <cid:cn35t8jf02@example.com>
Contact: sip:clientA@domainA.com
Require: recipient-list-invite, multiple-refer
Content-Type: multipart/related;

boundary=“boundary71”

Content-Length: [length]
--boundary71
Content-Type: application./resource-lists+xml
Content-Disposition: recipient-list
Content-ID: <cn35t8jf02@example.com>
<?xml version=“1.0” encoding=“UTF-8”?>
<resource-lists xmlns=“urn:ietf:params:xml:ns:resource-lists”

xmlns:xsi=“http://www.w3.org/2001/XMLSchema-instance”>

<list>

<entry uri=“sip:userB1@domainB.com?method=INVITE”/>
<entry uri=“sip:userB2@domainB.com?method=INVITE”/>

</list>
</resource-lists>
--boundary71
Content-Type: application/vnd.oma.isc.authinfo
Content-Transfer-Encoding: binary
Content-ID: <id2@clientA.domainA.com>
Content-Length: [length of authentication info data]
Content-Disposition: attachment
[Data containing authentication info for userA]
--boundary71--
Content-Type: text/plain
Content-ID: <id3@clientA.domainA.com>
Content-Length: [length of info about content to be delegated]
[Info about content to be delegated]
--boundary71--

As shown in Table 6, the SIP REFER message, according to an embodiment of the present invention, includes SIP address information of the client A 100, “sip:userA@domainA.com”, which is identification information of a delegation requester, in a “From” header. According to an embodiment of the present invention, when there are two delegation receivers, the SIP REFER message does not directly include identification information of a delegation receiver in an “Refer-To” header and includes identification information on the delegation receiver list in the “Refer-To” header. Table 6 shows the SIP REFER message on the assumption that the identification information of the delegation receiver list is “cn35t8jf02@example.com”. The delegation receiver list may include address information of the client B1 101, “sip:userB1@domainB.com”, and address information of the client B2 102, “sip:userB2@domainB.com”, as identification information of delegation receivers. In this case, the delegation receiver list additionally includes “method=INVITE” to each delegation receiver identification information, so that the client A 100 may request the server A 110 intended to receive the SIP REFER message to transmit a SIP INVITE message to each of the client B1 101 and the client B2 102. In addition, the SIP REFER message may include information on authority to use content. In an embodiment of the present invention, an MIME type, “application/vnd.oma.isc.authinfo”, is defined to forward the information on the authority to use the content, and such an MIME type is included in the SIP REFER messages, thereby indicating that the use authority information is included in the corresponding SIP REFER message. In addition, the SIP REFER message may include details on a content to be delegated. In an embodiment of the present invention, an MIME type, “text/plain”, is used to forward details on a content to be delegated. However, a new MIME type may be defined to forward details on a content to be delegated.

The server A 110, which receives the SIP REFER message requesting the delegation proposal from the client A 100, transmits a 202 Accepted message, which is a response message indicating that the function requested through the SIP REFER message will be performed, to the client A 100, in step 353, and transmits an SIP NOTIFY message to the client A 100, in step 355. In this case, the SIP NOTIFY message may be a message that should be transmitted to the client A 100 first in order to transmit a result of the request of the SIP REFER to the client A 100 afterward. The client A 100 transmits a response message 200 OK indicating that the message is successfully received from the server A 110, to the server A 110, in step 357.

The server A 110 identifies that the delegation receivers are the client B1 101 and the client B2 102 from the SIP REFER message requesting the delegation proposal, and transmits a SIP INVITE message indicating a delegation invitation to the server B 112 to which the client B1 101 and the client B2 102 belong, in steps 359 and 363. The server B 112 forwards the SIP INVITE messages received from the server A 110 to the client B1 101 and the client B2 102, in steps 361 and 365. Herein, as shown in Table 2 above, the SIP INVITE message transmitted to the client B1 101 may include SIP address information of the client A 100, “sip:userA@domainA.com”, in an “From” header, and may include address information of the client B1 101, “sip:userB1@domainB.com”, in a “To” header. In addition, the SIP INVITE message may include information on authority to use a content to be delegated by using an MIME type, “application/vnd.oma.isc.authinfo”, defined according to an embodiment of the present invention, and may include details on a content to be delegated by using an MIME type, “text/plain”. In addition, the SIP INVITE message may include additional information related to details on a content to be delegated under control of the server A 110. In addition, the SIP INVITE message transmitted to the client B2 101 may be configured in this method. Herein, steps 359 and 363 may be performed at a same point of time or may be performed serially.

Each of the client B1 101 and the client B2 102, which receive the SIP INVITE message indicating the delegation invitation, analyze the SIP INVITE message and provide the user with information indicating that delegation of the authority to use the specific content is proposed by the client A 100, and may determine whether to accept the delegation under control of the user. Herein, it is assumed that the client B1 101 decides to accept the delegation under control of the user, and the client B2 102 does not decide whether to accept the delegation or not.

The client B1 101, which decides to accept the delegation, transmits a 200 OK message indicating acceptance of the delegation invitation to the server B 112 to be delegated the authority to use the corresponding content, in step 367, and the server B 112 forwards the 200 OK message to the server A 110, in step 369. Herein, as shown in Table 3 above, the 200 OK message may include SIP address information of the client B1 101, “sip:userB1@domainB.com”, in a “From” header, thereby indicating that the client B 101 accepted the invitation of the client A 100, and may include an MIME type, “application/vnd.oma.isc.authinfo”, thereby informing that the corresponding message is a message indicating acceptance of the delegation of the content use authority.

The server A 110 may analyze the received 200 OK message and may identify that the client B1 101 accepted the delegation of the content use authority, and accordingly, a session may be formed between the server A 110 and the client B1 101.

The server A 110 generates an SIP CANCEL message indicating a withdrawal of the delegation invitation for the client B2 102 and transmits the SIP CANCEL message to the server B 112, in step 371. In this case, the SIP CANCEL message may be configured similarly to the SIP INVITE message. The server B 112 forwards the SIP CANCEL message to the client B2 102, in step 373. The client B2 102, which receives the SIP CANCEL message, may disregard the SIP INVITE message received in step 365 and may provide a user with information indicating that the proposal to delegate the authority to use the content is withdrawn. The client B2 102 transmits a response message 200 OK indicating that the SIP CANCEL message is received to the server B 112, instep 375. In this case, the server B 112 forwards a 200 OK message to the server A 110, in step 377.

The server A 110 generates viewing authority information to be transmitted to the client B1 101, in step 379. According to an embodiment of the present invention, the server A 110 may generate content use authority information to be transmitted to the client B1 101 or the client B2 102 prior to performing step 359 or may generate content use authority information to be transmitted to the client B1 101 or the client B2 102 at a time between steps 359 and 377. Herein, when the server A 110 generates content use authority information prior to receiving a 200 OK indicating acceptance of a delegation invitation from a specific client, the server A 110 cannot know which delegation receiver will accept the content use authority delegation proposal, and thus may generate temporary use authority information first, and when a delegation receiver is determined through a 200 OK message accepting the delegation invitation afterward, may modify the temporary use authority information according to the determined delegation receiver.

Thereafter, the server A 110 transmits an MSRP SEND message including the content use authority information to the server B 112, in step 381. The server B 112 forwards the MSRP SEND message to the client B1 101, in step 382. Accordingly, the client B1 101 may access or use the corresponding content based on the received content use authority information. Herein, as shown in Table 4 above, the MSRP SEND message may include content use authority information and may include an MIME type, “application/vnd.oma.isc.authinfo”, thereby indicating that the corresponding message includes the content use authority information.

The client B1 101 transmits a 200 OK message to the server B 112 in response to the MSRP SEND message, in step 383, and the server B 112 forwards the 200 OK message received from the client B1 101 to the server A 110, in step 384.

The server A 110 identifies that the authority to use the content successfully arrives at the client B1 101 through the 200 OK message and determines that the session with the client B 101 is no longer needed, and then transmits a SIP BYE message to end the session with the client B 101 to the server B 112, in step 385. The server B 112 which receives the SIP BYE message forwards the SIP BYE message to the client B 101, in step 386.

Thereafter, the client B1 101 transmits a 200 OK message to the server B 112 as a response message to the end of the session, in step 387, and the server B 112 forwards the 200 OK message received from the client server B1 101 to the server A 110, in step 388. Accordingly, the session between the server A 110 and the client B1 101 ends.

Thereafter, the server A 110 transmits an SIP NOTIFY message to notify that the authority to use the content is delegated to the client B1 101, to the client A 100, in step 389. Herein, as shown in Table 5 above, the SIP NOTIFY message includes user identification information of the client B1 101 and address information of the client B1 101 in an “(original)” parameter from among SDP response parameters, thereby informing the client A 100 of which client or which user is delegated the authority to use the content. In addition, the SIP NOTIFY message includes an MIME type, “application/vnd.oma.isc.authinfo”, defined in an embodiment of the present invention, thereby indicating that the corresponding message is a message related to the delegation of the content use authority.

Thereafter, the client A 100 transmits a 200 OK message to the server A 110 in response to the SIP NOTIFY message, in step 391, and deletes the information on the authority to use the content, which is delegated to the client B 101, in step 393. In addition, the server A 110 receives a response message to the SIP NOTIFY message from the client A 100 and then deletes the content use authority information on the client A 100, in step 395. That is, since the authority of the client A 100 to use the content is delegated to the client B1 101, the client A 100 loses the authority to use the corresponding content. According to an embodiment of the present invention, the client A 100 and the server A 110 may not delete the information on the authority to use the content and may add information indicating that the use authority is not effective (e.g., an usable flag), in steps 393 and 395.

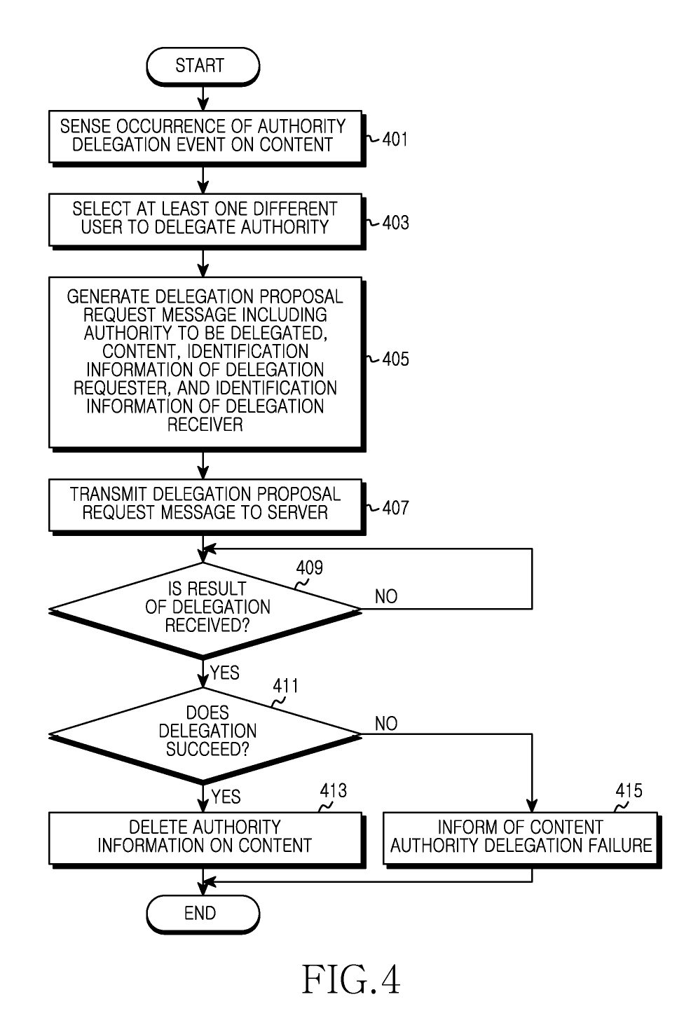

FIG. 4 is a flowchart illustrating a procedure for delegating authority to use multimedia content to another user terminal in a user terminal of a communication system, according to an embodiment of the present invention.

Referring to FIG. 4, a user terminal detects an event to delegate authority to use specific content to another user (or another user terminal), in step 401. The user terminal selects at least one another user to delegate the authority to use the specific content under control of the user, in step 403. Thereafter, the user terminal generates a delegation proposal request message including information on authority to use a specific content, details on the specific content, identification information of a delegation requester, and identification information of a delegation receiver, in step 405. The information on the authority to use the content may include information such as, for example, a login ID, a password, and an authority token. The information on the details of the content may include information such as, for example, a content title, an airtime, and channel information. The identification information of the delegation requester may include address information of a user terminal. The identification information of the delegation receiver may include address information of another user terminal selected under control of the user.

The user terminal transmits the delegation proposal request message to a server, in step 407, and checks whether a message indicating a result of the delegation is received from the server or not, in step 409. When the message indicating the result of the delegation is received, the user terminal determines whether the result message of the delegation indicates delegation success or not, in step 411.

When the result message of the delegation indicates the delegation success, the user terminal deletes the information on the authority to use the specific content, in step 413. Herein, the user terminal may acquire information on another user delegated the authority to use the corresponding content from the result message of the delegation, and may output the information on the delegated another user through a user interface.

On the other hand, when the result message of the delegation does not indicate delegation success, that is, when the message indicates delegation failure, the user terminal outputs information indicating that the user terminal fails to delegate the authority to use the corresponding content to another user through the user interface, in step 415. Herein, when the proposal to delegate the content use authority is not accepted by another user terminal for a predetermined time or an effective time of use authority, a delegation failure message may be received from the server.

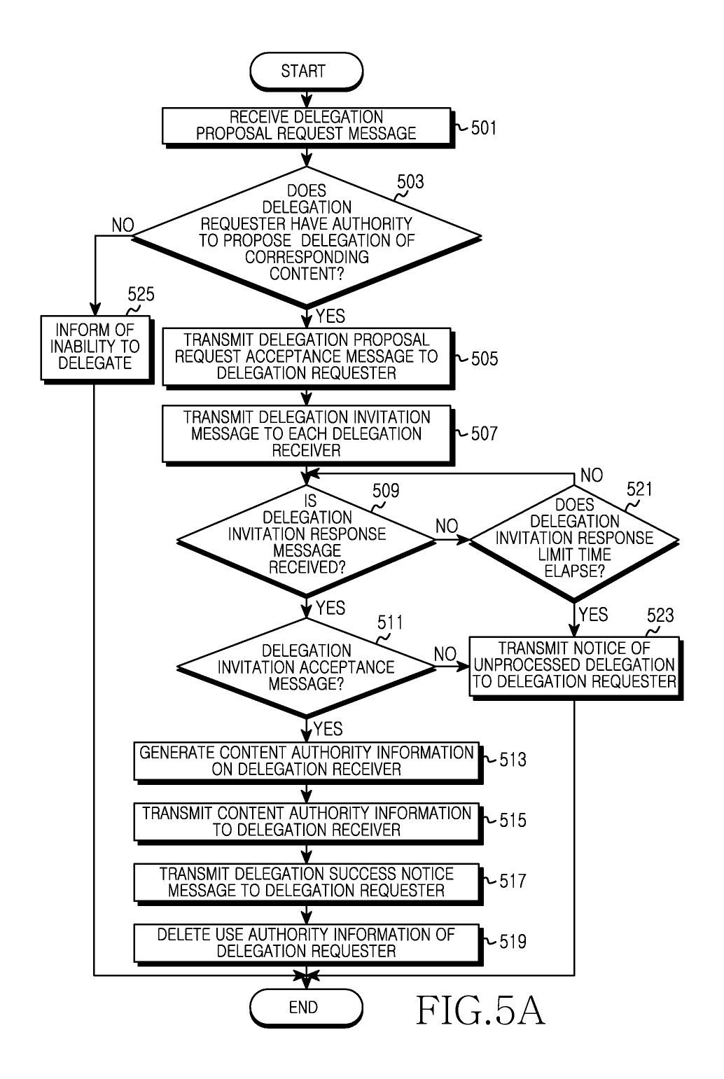

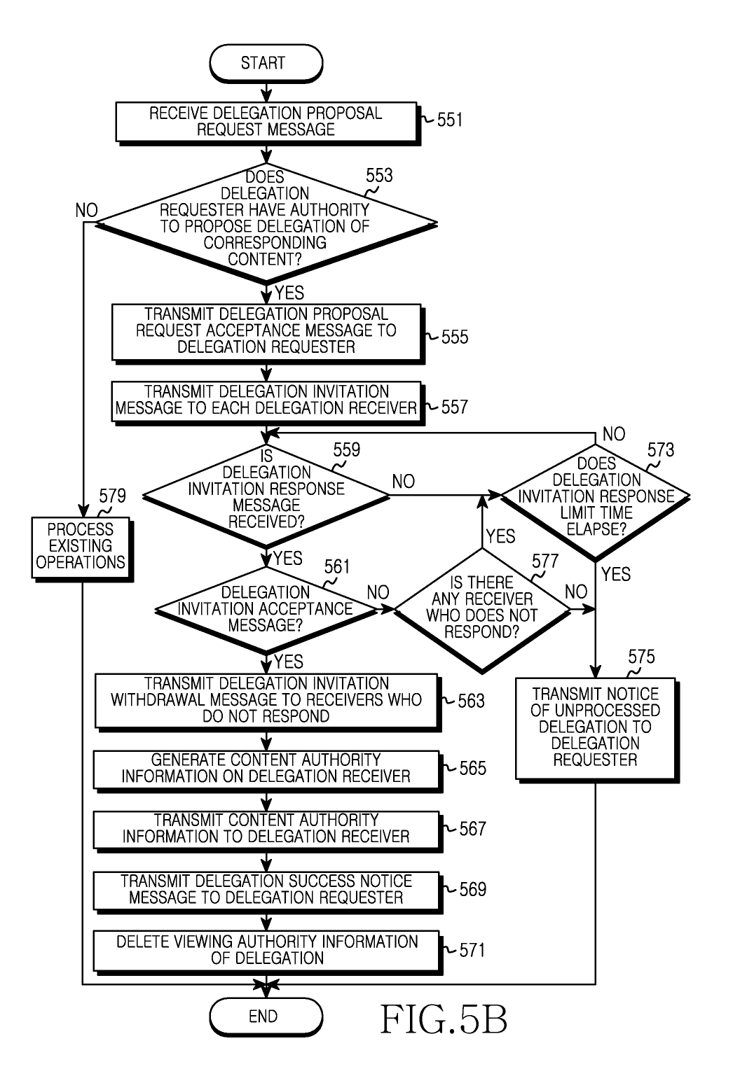

FIG. 5A is a flowchart illustrating a procedure for delegating authority of a specific user terminal to use multimedia content to another user terminal in a server of a communication system, according to an embodiment of the present invention. Herein, it is assumed that there is a single client to be delegated authority to use content, namely, there is a single delegation receiver.

Referring to FIG. 5A, a server receives a delegation proposal request message for requesting to delegate authority to use specific content to another user from a specific user terminal, in step 501. The server may determine the received message as a delegation proposal request message based on identification information included in a title, a header or a body of the received message. In addition, the server may identify a delegation requester which requests to delegate authority to use a content, a delegation receiver to be delegated authority to use a content, content use authority to be delegated, and information related to details of a content to be delegated, from the delegation proposal request message.

The server determines whether the user terminal which transmitted the delegation proposal request message, that is, the delegation requester, has authority to propose delegating the corresponding content or not, in step 503. That is, the server may determine whether the delegation requester has the authority to propose delegating based on whether the delegation requester has the authority to use the corresponding content or not. In addition, according to another embodiment of the present invention, the server may determine whether the delegation requester has the authority to propose delegating based on whether the delegation requester acquires the authority to use the content by purchasing the content or whether the delegation requester is delegated the authority to use the content by another user terminal, based on information recorded in the server. That is, when the delegation requester acquires the authority to use the content by purchasing the content, the server determines that the delegation requester has the authority to propose delegating the content, and, when the delegation requester is delegated the authority to use the content by another user terminal, the server determines that the delegation requester does not have the authority to propose delegating the content.

When the delegation requester does not have the authority to propose delegating the content, the server transmits a message indicating that it is impossible to delegate the authority to use the content to the delegation requester terminal, in step 525.

When the delegation requester has the authority to propose delegating the content, the server transmits an acceptance message to the delegation requester terminal in response to the delegation proposal request, in step 505. That is, the server may inform that the server will proceed with a process for delegating the authority to use the content to another user by transmitting the acceptance message in response to the delegation proposal request.

Thereafter, the server transmits a delegation invitation message to a delegation receiver terminal, in step 507. Thereafter, the server checks whether a delegation invitation response message is received or not, in step 509. When the delegation invitation response message is received, the server determines whether the received response message is a delegation invitation acceptance message or not, in step 511. Herein, the delegation invitation acceptance message may indicate that the corresponding delegation receiver wishes to be delegated the authority to use the content.

When the received response message is the delegation invitation acceptance message, the server generates content authority information on the delegation receiver, in step 513, and then transmits the generated content authority information to the delegation receiver, in step 515. The server transmits a delegation success notification message to the delegation requester terminal, in step 517, and deletes use authority information of the delegation requester, in step 519.

When the received response message is a delegation invitation denial message, the server transmits a message informing the delegation requester terminal of delegation failure or unprocessed delegation, in step 523. In this case, the server may inform the delegation requester terminal that the delegation fails due to the denial by the delegation receiver.

When the delegation invitation response message is not received, the server determines whether a delegation invitation response limit time elapses or not, in step 521. When the delegation invitation response limit time does not elapse, the server resumes step 509 to check whether the delegation invitation response message is received or not, and, when the delegation invitation response limit time elapses, the server transmits the message informing delegation failure or unprocessed delegation to the delegation requester terminal, in step 523. In this case, since the response of the delegation receiver is not received within the delegation invitation response limit time, the server may inform the delegation requester terminal of the delegation failure.

FIG. 5B is a flowchart illustrating a procedure for delegating authority of a specific user terminal to use multimedia content to another user terminal in a server of a communication system, according to another embodiment of the present invention. Herein, it is assumed that there are two candidate clients to be delegated authority to use content, namely, there are two delegation receivers, and one of the two delegation receivers is delegated authority to use a content. In an embodiment of the present invention described below, the same method applies when there are two or more delegation receivers to be delegated authority to use content.

Referring to FIG. 5B, a server receives a delegation proposal request message for requesting to delegate authority to use specific content to another user from a specific user terminal, in step 551. The server may determine the received message as a delegation proposal request message based on identification information included in a title, a header or a body of the received message. In addition, the server may identify a delegation requester which requests to delegate authority to use a content, a delegation receiver to be delegated authority to use a content, content use authority to be delegated, and information related to details of a content to be delegated, from the delegation proposal request message.

The server determines whether the user terminal, which transmitted the delegation proposal request message, that is, the delegation requester, has authority to propose delegating the corresponding content or not, in step 553. That is, the server may determine whether the delegation requester has the authority to propose delegating based on whether the delegation requester has the authority to use the corresponding content or not. In addition, according to another embodiment of the present invention, the server may determine whether the delegation requester has the authority to propose delegating based on whether the delegation requester acquires the authority to use the content by purchasing the content or whether the delegation requester is delegated the authority to use the content by another user terminal, based on information recorded in the server. That is, when the delegation requester acquires the authority to use the content by purchasing the content, the server determines that the delegation requester has the authority to propose delegating the content, and, when the delegation requester is delegated the authority to use the content by another user terminal, the server determines that the delegation requester does not have the authority to propose delegating the content.

When the delegation requester does not have the authority to propose delegating the content, the server transmits a message indicating that it is impossible to delegate the authority to use the content to the delegation requester terminal, in step 579.

When the delegation requester has the authority to propose delegating the content, the server transmits an acceptance message to the delegation requester terminal in response to the delegation proposal request, in step 555. That is, the server may inform that the server will proceed with a process for delegating the authority to use the content to another user by transmitting the acceptance message in response to the delegation proposal request.

Thereafter, the server transmits a delegation invitation message to each delegation receiver, in step 557. Thereafter, the server checks whether a delegation invitation response message is received or not, in step 559. When the delegation invitation response message is received, the server checks whether the received response message is a delegation invitation acceptance message or not, in step 561. Herein, the delegation invitation acceptance message may indicate that the corresponding delegation receiver wishes to be delegated the authority to use the content.

When the received response message is the delegation invitation acceptance message, the server transmits an invitation withdrawal message to each of the delegation receiver terminals from which a delegation invitation response message has not been received from among a plurality of delegation receivers, in step 563. That is, the server determines a delegation receiver that accepted the delegation invitation first from among the plurality of delegation receivers included in the delegation proposal request message, as a delegation receiver to be delegated the authority to use the content, and transmits a message indicating the withdrawal of the delegation invitation to terminals of the other delegation receivers.

Thereafter, the server generates content use authority information on the determined delegation receiver, in step 565 and then transmits the generated content use authority information to the delegation receiver terminal, in step 567. Thereafter, the server transmits a delegation success notification message to the delegation requester terminal, in step 569. In this case, the delegation success notification message may include identification information of the delegation receiver that is determined to be delegated the authority to use the content. Thereafter, the server deletes the use authority information of the delegation requester, in step 571.

When the received response message is a delegation invitation denial message, the server determines whether there is a delegation receiver that does not respond to the delegation invitation message, in step 577. That is, the server determines whether there is a delegation receiver that does not respond to the delegation invitation message from among the plurality of delegation receivers included in the delegation proposal request message. When there is the delegation receiver that does not respond to the delegation invitation message, the server resumes step 559 to check whether a delegation invitation response message is received or not. When there is no delegation receiver that does not respond to the delegation invitation message, that is, when all delegation receivers deny the delegation invitation, the server transmits a message informing delegation failure or unprocessed delegation to the delegation requester terminal, in step 575. In this case, the server may inform the delegation requester terminal that the delegation fails due to the denial by the delegation receivers.

When the delegation invitation response message is not received as a result of the checking, in step 559, the server determines whether a delegation invitation response limit time elapses or not, in step 573. When the delegation invitation response limit time does not elapse, the server resumes step 559 to check whether the delegation invitation response message is received or not. When the delegation invitation response limit time elapses, the server transmits the message informing delegation failure or unprocessed delegation to the delegation requester terminal, in step 575. In this case, since the responses of the delegation receivers are not received within the delegation invitation response limit time, the server may inform the delegation requester terminal of the delegation failure.

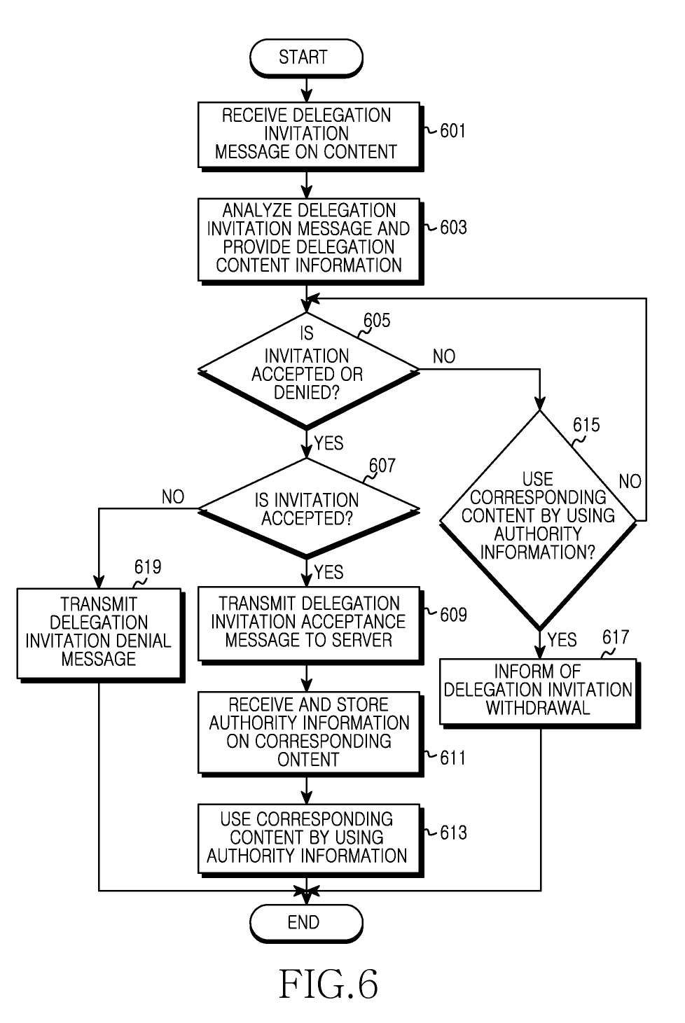

FIG. 6 is a flowchart illustrating a procedure for being delegated authority to use a multimedia content by another user terminal in a user terminal of a communication system, according to an embodiment of the present invention.

Referring to FIG. 6, a user terminal receives a delegation invitation message regarding content, in step 601. That is, the user terminal may receive a message asking whether the user terminal will be delegated authority to use a specific content from a specific user terminal through a server. In this case, the delegation invitation message may include information on details of a content to be delegated.

The user terminal analyzes the delegation invitation message, in step 603, and provides information on details of the content to be delegated. For example, the user terminal may analyze the delegation invitation message and may output information indicating that a specific user terminal wishes to delegate authority to view a program to be aired at channel 1 from 2 p.m. to 3 p.m. to itself through a user interface.

The user terminal determines whether the delegation invitation is accepted or denied under control of a user, in step 605. The user terminal may provide a user interface for selecting acceptance or denial of the delegation invitation, and may check whether the delegation invitation is accepted or denied by the user through the user interface.

When the delegation invitation is accepted or denied under the control of the user, the user terminal checks whether the invitation is accepted or not, in step 607. When the delegation invitation is accepted, the user terminal transmits a delegation invitation acceptance message to the server, in step 609, and receives information on the authority to use the content from the server and stores the user authority information, in step 611. Thereafter, the user terminal uses the corresponding content by using the use authority information, in step 613.

When the delegation invitation is denied, the user terminal transmits a delegation invitation denial message to the server, in step 619.

When the delegation invitation is neither accepted nor denied, the user terminal determines whether a delegation invitation withdrawal message is received or not, in step 615. That is, when the delegation invitation is neither accepted nor denied within a delegation invitation response limit time, the user terminal may receive the delegation invitation withdrawal message from the server. This may be because another user terminal accepted the delegation invitation first.

When the delegation invitation withdrawal message is not received, the user terminal resumes step 605. When the delegation invitation withdrawal message is received, the user terminal informs that the delegation invitation is withdrawn through the user interface, in step 617.

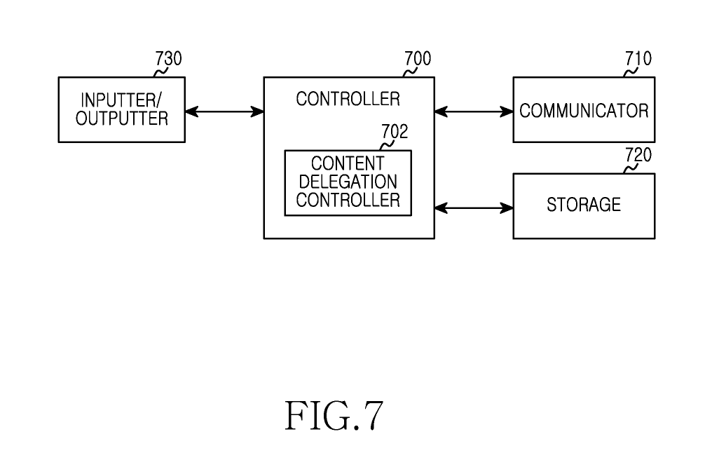

FIG. 7 is a diagram illustrating a block configuration of a user terminal in a communication system, according to an embodiment of the present invention.

Referring to FIG. 7, a user terminal includes a controller 700, a communicator 710, a storage 720, and an inputter/outputter 730.

The controller 700 controls and processes overall functions of the terminal. According to an embodiment of the present invention, the controller 700 controls and processes a function of delegating authority to use a content to another user terminal through a content delegation controller 702, or a function of being delegated authority to use a content by another user terminal.

The content delegation controller 702 controls and processes a function of detecting an event to delegate content use authority owned by a terminal or a user to another user, and selecting at least one another user delegate authority to use content. The content delegation controller 702 controls and processes a function of generating a delegation proposal request message including information on authority to use content, information on details of content, identification information of a delegation requester, and identification information of a delegation receiver, and transmitting the generated delegation proposal request message to a server. Herein, the information on the authority to use the content may include information such as, for example, a login ID, a password, and an authority token. The information on the details of the content may include information such as, for example, a content title, an airtime, and channel information. The identification information of the delegation requester may include address information of the user terminal. The identification information of the delegation receiver may include address information of the at least one another user terminal selected under control of the user. The delegation proposal request message may include information as shown in Tables 1 to 6. When a message indicating that the authority to use the content is successfully delegated is received from the server, the content delegation controller 702 may delete the content use authority information stored in the storage 720 or may add information indicating that the corresponding information is not effective in the content use authority information.

When a delegation invitation message is received from another user terminal, the content delegation controller 702 performs a control function to analyze the delegation invitation message and determine whether to be delegated authority to use content. That is, the content delegation controller 702 controls and processes a function of informing that authority to use a content is proposed through the inputter/outputter 730, and requesting the user to set whether to be delegated the authority to use the content. The content delegation controller 702 controls and processes a function of generating an acceptance or denial message in response to the request for the delegation of the content use authority according to user's setting, and transmitting the acceptance or denial message to the server. The content delegation controller 702 controls and processes a function of receiving the authority to use the content from the server and storing the received authority to use the content in the storage 720. When a delegation invitation withdrawal message is received from the server, the content delegation controller 702 controls and processes a function of informing the user that the delegation of the authority to use the content is withdrawn through the inputter/outputter 730. The functions of the controller 700 described above may be performed by instructions included in at least one program stored in the storage 720.

The communicator 710 exchanges signals with a user terminal in a wired or wireless manner. The communicator 710 may include a wired transceiver, a radio frequency transceiver, and/or a light (e.g., infrared ray) transceiver. For example, the communicator 710 may include a communication system supporting any one of a Global System for Mobile Communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless Fidelity (Wi-Fi) network, Near Field Communication (NFC), IrDa, a WiMax network or/and a Bluetooth network. The communication system, according to an embodiment of the present invention, is not limited to a communication system supporting the above-described networks, and may be a communication system supporting other networks. According to an embodiment of the present invention, the communicator 710 exchanges signals for delegating content with the server under control of the controller 700.

The storage 720 may store at least one program including instructions to perform embodiments of the present invention. The storage 720 stores data, which is generated while embodiments of the present invention are performed. The storage 720 may store information on authority to use a content and information on details of content. The storage 720 may store identification information of the user terminal and identification information of another user terminal. The identification information of the user terminal may include address information of the user terminal.

The inputter/outputter 730 provides an interface between the user and the terminal. The inputter/outputter 730 includes a touch-sensitive display, a keypad, a speaker, and a microphone, and provides an interface for inputting and outputting data between the user and the terminal. According to an embodiment of the present invention, the inputter/outputter 730 may display a graphic element for allowing the user to set to delegate authority to use content to another user under control of the content delegation controller 702, and may detect a user input for requesting to delegate authority to use a specific content to another user. The inputter/outputter 730 may detect a user input for selecting another user to be delegated authority to use content. The inputter/outputter 730 may display a graphic element indicating whether delegation of authority to use content succeeds or fails. The inputter/outputter 730 may display a graphic element indicating that delegation of authority to use specific content is proposed by another user and allowing the user to set whether to accept this proposal. The inputter/outputter 730 may detect a user input for setting whether to accept the proposal to delegate the authority to use the content. The inputter/outputter 730 may display a graphic element indicating that the proposal to delegate the authority to use the content is withdrawn.

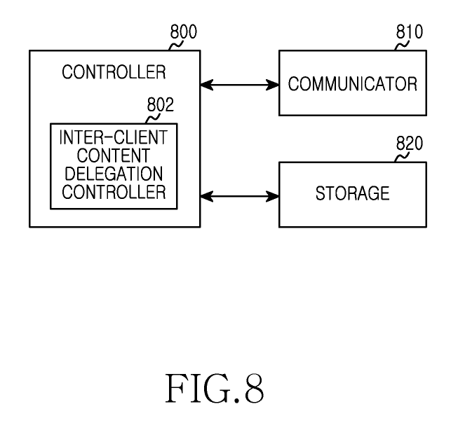

FIG. 8 is a diagram illustrating a block configuration of a server in a communication system, according to an embodiment of the present invention.

Referring to FIG. 8, a server includes a controller 800, a communicator 810, and a storage 820.

The controller 800 controls and processes a function of providing content to a corresponding user terminal which acquires authority to use the content by purchasing the content or subscribing to a service. In particular, the controller 800 includes an inter-client content delegation controller 800 to control and process a function of delegating authority to user for content, which is acquired by a specific user terminal, to another user terminal.

That is, when a delegation proposal request message for requesting to delegate authority to use specific content to another user terminal is received from a specific user terminal, the inter-client content delegation controller 800 controls and processes a function of transmitting a delegation invitation message asking at least one another user terminal about whether to be delegated the authority to use the content and forming a session with another user terminal which accepted the delegation invitation. The inter-client content delegation controller 800 controls and processes a function of generating content use authority for another user who accepted the delegation invitation to use the content on behalf of the specific user terminal, and transmitting the generated content use authority to another user. After transmitting the content use authority to another user terminal, the inter-client content delegation controller 800 controls and processes a function of deleting the content use authority of the specific user or changing the content use authority of the specific user to be in an ineffective state. When the inter-client content delegation controller 800 transmits the delegation invitation message to a plurality of other user terminals, the inter-client content delegation controller 800 controls and processes a function of transmitting a message indicating withdrawal of the delegation invitation to user terminals except the user terminal accepting the delegation invitation from among the plurality of other user terminals. When a message for accepting the delegation invitation is not received within a delegation invitation response limit time, the inter-client content delegation controller 800 controls and process a function of informing the specific user terminal, which requested to delegate the authority to use the content of delegation failure. The functions of the controller 800 described above may be performed by instructions included in at least one program stored in the storage 820.

The communicator 810 exchanges signals with a user terminal in a wired or wireless manner. The communicator 810 may include a wired transceiver, a radio frequency transceiver, and/or a light (e.g., infrared ray) transceiver. For example, the communicator 810 may include a communication system supporting any one of a GSM network, an EDGE network, a CDMA network, a W-CDMA network, an LTE network, an OFDMA network, a Wi-Fi network, NFC, IrDa, a WiMax network or/and a Bluetooth network. The communication system, according to an embodiment of the present invention, is not limited to a communication system supporting the above-described networks, and may be a communication system supporting other networks. According to an embodiment of the present invention, the communicator 810 exchanges signals for delegating content between the user terminals under control of the controller 800.

The storage 820 may store at least one program including instructions to perform embodiments of the present invention. The storage 820 stores data, which is generated while embodiments of the present invention are performed. The storage 820 may store information on authority of each user terminal to use a content and information on details of content.

As described above, the specific client loses the authority to use the content after delegating the authority to use the content to another client. However, when the content use authority includes the number of times the content is used or a using time of the content according to a design method, the specific client delegates only a part of the number of times the content is used and/or a part of the using time out of the total number of times the content is used and/or the total using time to another client, and may use the corresponding content based on the remaining number of times the content is used and/or the remaining using time section.

According to embodiments of the present invention, authority to use multimedia content is delegated between users based on an SIP in a communication system supporting an ISC, so that the multimedia content purchased by the user terminal can be prevented from being wasted without being consumed and desires to purchase paid contents can be grown.

Embodiments of the present invention can be realized in the form of hardware, software, or a combination of hardware and software. The software may be stored in a volatile storage medium or a non-volatile storage medium. The storage medium may include a storage device like a Read Only Memory (ROM), a memory device like a Random Access Memory (RAM), a memory chip, or an integrated circuit, and an optical or magnetical recording medium such as a Compact Disc (CD), a Digital Versatile Disc (DVD), a magnetic disk or a magnetic tape, or the like. The storage device or the storage medium is a machine language-readable storage that is suitable for storing a program including instructions for realizing the present invention. Accordingly, embodiments of the present invention provide a program including a code for implementing an apparatus or a method claimed in the claims of this specification. Still further, such programs may be distributed through a wireless or wired communication network and may be stored and executed in a distribution method.

The term “include” used in this specification and its changed form “including” have a meaning “includes but is not limited to” and do not preclude additional configuration, component, or process.

The singular forms used in this specification include the plural forms unless the context clearly indicates otherwise. In particular, the indefinite articles, when used in this specification, are interpreted as including singular forms and plural forms.

The shapes, numbers, features, and groups described in relation to embodiments of the present invention can be used in other embodiments unless they are incompatible.

The term “X for Y” used throughout the specification (“Y” means an action or a process and “X” indicates a means for performing that action or process) include X specifically arranged or applied to perform, but not limited to, Y.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method of a terminal for delegating content in a communication system, the method comprising the steps of:
detecting, by the terminal, an event for delegating authority to use the content;
selecting, by the terminal, at least one other terminal to which the authority can be delegated;
transmitting, from the terminal, to a server, a message requesting to delegate the authority to the selected at least one other terminal; and
receiving, at the terminal, a result indicating whether the authority is successfully delegated from the server.

2. The method of claim 1, wherein the message requesting to delegate the authority comprises information of the authority, information related to details of the content, identification information of the terminal, and identification information of each of the at least one other terminal.

3. The method of claim 1, further comprising, when a result indicating that the authority is successfully delegated is received from the sever, processing the authority of the terminal into an unusable state.

4. A method of a server for delegating content between terminals in a communication system, the method comprising the steps of:
receiving, at the server, from a first terminal, a message requesting to delegate authority to use the content to at least one other terminal;
delegating, by the server, the authority of the first terminal to the at least one other terminal; and
transmitting, from the server, to the first terminal, a result indicating whether the authority is successfully delegated or not.

5. The method of claim 4, wherein delegating the authority of the first terminal to the other terminal comprises:
transmitting, from the server, to the at least one other terminal, a message asking whether delegation of the authority is accepted or not;
checking, by the server, whether a message is received that indicates whether the delegation of the content use authority is accepted or not; and
when a delegation acceptance message is received, transmitting information on the authority to one of the at least one other terminal corresponding to the delegation acceptance message.

6. The method of claim 5, further comprising, when the at least one other terminal comprises a plurality of other terminals, transmitting a message informing of withdrawal of delegation of the authority to terminals except the one of the at least one other terminal corresponding to the delegation acceptance message from among the plurality of terminals.

7. The method of claim 5, further comprising, when a delegation denial message is received from the at least one other terminal, determining that delegation of the authority fails.

8. The method of claim 4, further comprising, after delegating the authority of the first terminal to the at least one other terminal, processing the authority of the first terminal into an unusable state.

9. A method of a terminal for being delegated content in a communication system, the method comprising the steps of:
receiving, at the terminal, from a server, authority delegated by a first terminal, to use the content; and
using, by the terminal, the content based on the authority of the first terminal.

10. The method of claim 9, wherein receiving the delegated authority of the first terminal comprises:
receiving, at the terminal, from the server, a message asking whether delegation of the authority of the first terminal is accepted or not;
determining, by the terminal, whether to accept the delegation of the authority based on a user input; and
transmitting, from the terminal, to the server, a message indicating whether the authority is accepted or not.

11. A terminal for delegating content in a communication system, the terminal comprising:
a communicator configured to exchange signals with a server; and
a controller configured to control functions of detecting an event for delegating authority to use the content, selecting at least one other terminal to which the authority can be delegated, transmitting to the server a message requesting to delegate the authority to the selected at least one another terminal, and receiving a result indicating whether the authority is successfully delegated from the server.

12. The terminal of claim 11, wherein the message requesting to delegate the authority comprises information of the authority, information related to details of the content, identification information of the terminal, and identification information of each of the at least one other terminal.

13. The terminal of claim 11, wherein, when a result indicating that the authority is successfully delegated is received from the sever, the controller processes the authority of the terminal into a unusable state.

14. A server for delegating content between terminals in a communication system, the server comprising:
a communicator configured to exchange signals with a plurality of terminals; and
a controller configured to control functions of receiving from a first terminal a message requesting to delegate authority to use the content to at least one other terminal, delegating the authority of the first terminal to the at least one other terminal, and transmitting a result indicating whether the authority is successfully delegated or not to the first terminal.

15. The server of claim 14, wherein the controller is further configured to control functions of transmitting a message asking whether delegation of the authority is accepted or not, checking whether a message is received that indicates whether the delegation of the content use authority is accepted or not, and, when a delegation acceptance message is received, transmitting information on the authority to one of the at least one other terminal corresponding to the delegation acceptance message.

16. The server of claim 15, wherein, when the at least one other terminal comprises a plurality of other terminals, the controller is further configured to perform a function of transmitting a message informing of withdrawal of delegation of the authority to terminals except the one of the at least one other terminal corresponding to the delegation acceptance message from among the plurality of terminals.

17. The server of claim 15, wherein, when a delegation denial message is received from the at least one other terminal, the controller is further configured to determine that delegation of the authority fails.

18. The server of claim 14, wherein, after delegating the authority of the terminal to the at least one other terminal, the controller is further configured to process the authority of the first terminal into an unusable state.

19. A terminal for being delegated content in a communication system, the terminal comprising:
a communicator configured to exchange signals with a server; and
a controller configured to control functions of receiving authority delegated by a first terminal, to use the content from the server, and using the content based on the authority of the first terminal.

20. The terminal of claim 19, wherein the controller is further configured to control functions of receiving, from the server, a message asking whether delegation of the authority of the first terminal is accepted or not, determining whether to accept the delegation of the authority based on a user input, and transmitting a message indicating whether the authority is accepted or not to the server.
